(19) United States
(12) Patent Application Publication
(10) Pub. No.: US 2013/0257065 A1
(43) Pub. Date: Oct. 3, 2013

(54) CART BAY DOOR PADDLE LATCH

(71) Applicant: B/E AEROSPACE, INC., Wellington, FL (US)

(72) Inventor: Peter John Leslie Burd, Carmarthenshire (GB)

(73) Assignee: B/E Aerospace, Inc., Wellington, FL (US)

(21) Appl. No.: 13/851,257

(22) Filed: Mar. 27, 2013

Related U.S. Application Data
(60) Provisional application No. 61/617,507, filed on Mar. 29, 2012.

(51) Int. Cl. E05C 1/00

(52) U.S. Cl. CPC E05C 1/004
USPC 292/175; 292/145

(57) ABSTRACT

A latch for a galley cart bay door is disclosed having a pivoting handle rotating about a spindle, and a fork connected to the spindle for rotation with the pivoting handle. A drive link is mounted on the fork, such that a downward movement of the pivoting handle results in an upward movement of the drive link. The drive link moves a reciprocating retention block into and out of a chamber above the cart bay door, whereby the cart bay door can be secured by driving the retention block into the chamber by a downward movement of the pivoting handle.

### CROSS-REFERENCES TO RELATED APPLICATIONS

This application claims priority from U.S. application No. 61/617,507, filed Mar. 29, 2012, the contents of which are fully incorporated herein by reference.

### BACKGROUND

Beverage service on an aircraft is usually accomplished by attendants who wheel beverage carts down the aisles of the plane, providing drinks to those passengers that request them. The challenge with most beverage carts used in today's aircraft is that these units are quite heavy and mobile, and in the event of turbulence or other aircraft movement these units can shift or even begin moving if not properly constrained, leading to a danger risk. Also, storing these carts when not in use requires that they be securely stationed, but easily and quickly released when needed. Accordingly, these carts are provided with immobilization systems that attempt to keep the beverage carts stationary when not in use but is easily disengaged when the cart needs to be released for serving the passengers.

In order to retain a catering cart within a commercial aircraft during normal service and in emergency conditions, carts are normally equipped with retraining devices commonly known as “turn buttons” that are deployed to secure the carts in place. The turn buttons are levers or handles that are rotated downward, causing the cart to engage with a lower surface of a work deck beam. However, turn buttons have inherent drawbacks in their design.

One disadvantage concerns the current trend towards the “air over” method of cart chilling that requires the cart bays to have doors. This means that the turn buttons have to be placed either on the outside of the doors or inside the doors. If placed outside the doors, there is a resultant increase in the depth of the galley when the carts are stored in the galley, and the turn buttons are visible to the observer, leading to a poor aesthetic appearance of the cart. There are also issues with ergonomics in having the turn button outside the doors. Alternatively, the turn buttons can be located on the inside of the bay doors, but this also leads to a resultant increase in the depth of a galley, and an increase in the work deck height. There are also potential cold bridge issues through the doors themselves, i.e., thermal losses resulting from conduction via the turn buttons. In this case, the doors are not normally used for retention (with the possible exception of cart kick-up loads), although additional door latching is required to secure the doors themselves.

To release the carts, both turn buttons need to be stowed which requires the use of both hands or a repeated single action, and there is no simultaneous “close-lock” operation available with this design in an emergency.

### SUMMARY OF THE INVENTION

The present invention is a paddle latch that is integrated into an aircraft beverage cart bay door that acts as a brake actuator to secure the cart and its contents. The paddle latch comprises an actuator such as a paddle that rotates or pivots on a spindle and is coupled to an actuation fork. The actuation fork is connected to an articulating link that engages and moves a latch block. Movement of the paddle downward from its extended position to a vertical orientation rotates the fork upward, which in turn drives the link that extends the block. The latch features a manual release and can either be manually closed, or have the option of an automatic deadlock operation that results in a “close-lock” feature.

Other features and advantages of the present invention will become more apparent from the following detailed description of the preferred embodiments in conjunction with the accompanying drawings, which illustrate, by way of example, the operation of the invention.

### BRIEF DESCRIPTION OF THE DRAWINGS

FIG. 1 is a cross sectional view, taken from the side, of a first preferred embodiment of the present invention, comprising a cart bay door latch in the open position;

FIG. 2 is a cross sectional view, taken from the side, of the embodiment of FIG. 1, comprising the latch in the closed position; and

FIG. 3 is a front view of the latch of FIG. 1.

### DETAILED DESCRIPTION OF THE PREFERRED EMBODIMENTS

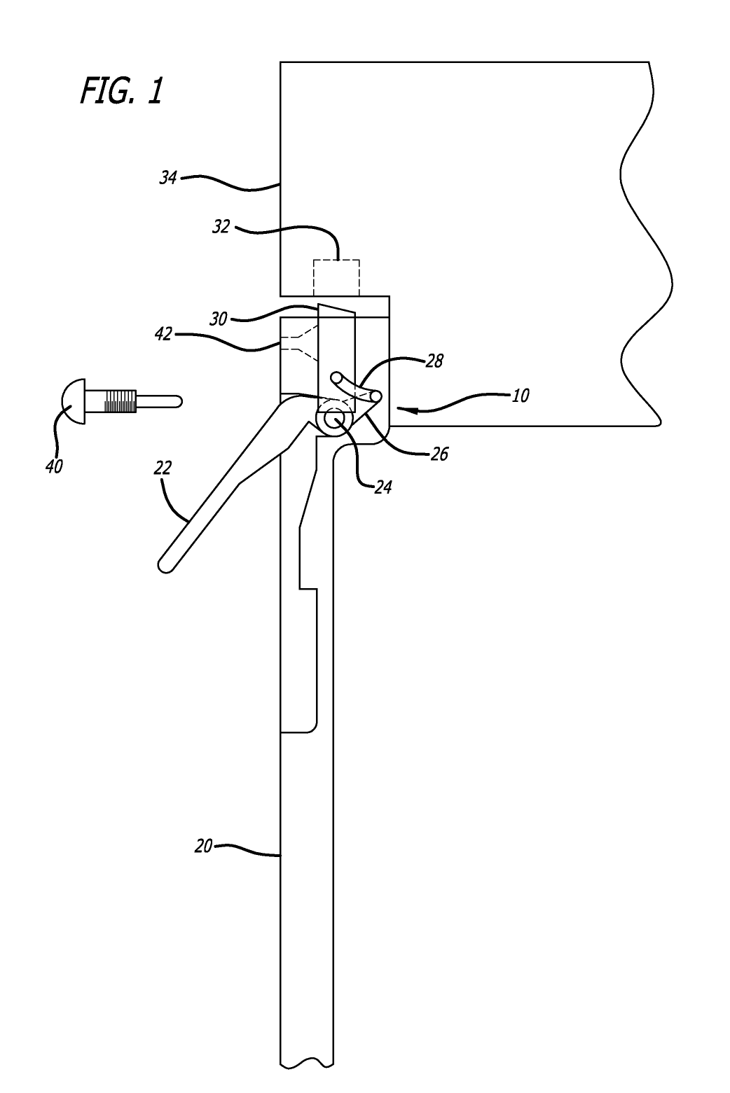

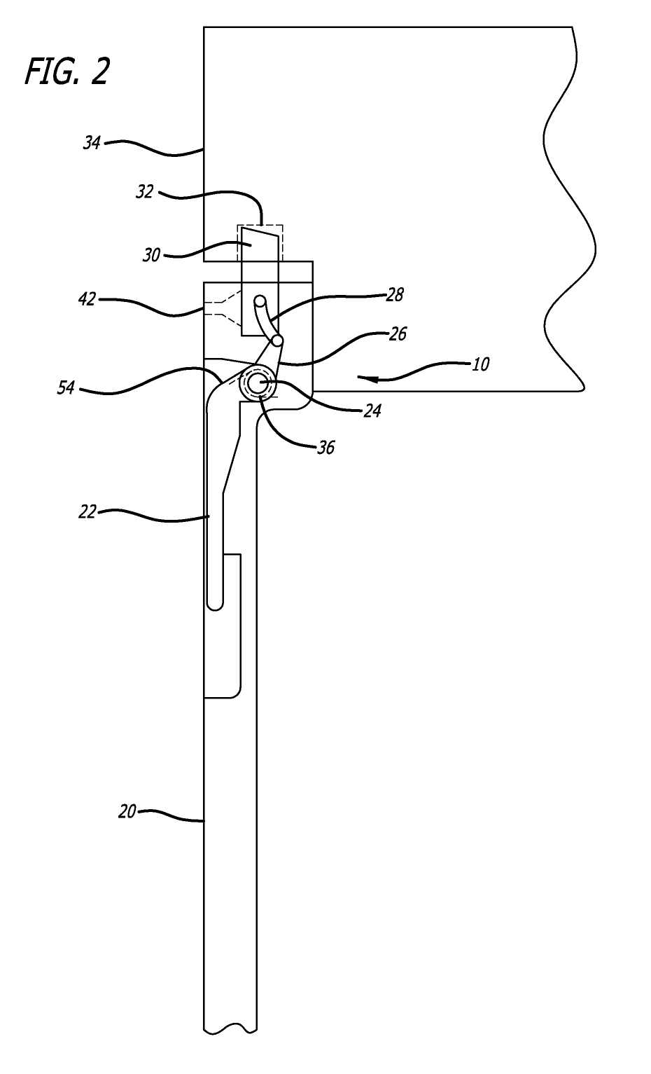

In the galley of an aircraft, the bays that house the beverage carts are latched for convenience and safety. The present invention is a paddle latch assembly that is integrated into an aircraft beverage cart bay door 20 that also serves as a brake actuator to secure the cart and its contents. The paddle latch 10 comprises an actuator such as a paddle 22 that rotates or pivots on a spindle 24 as shown in FIGS. 1 and 2. The paddle 22 is coupled to an actuation fork 26, which in turn is connected to an articulating link 28 that engages and moves a latch block 30. As shown in FIGS. 1 and 2, movement of the paddle 22 downward from its extended position (FIG. 1) to a vertical orientation (FIG. 2) rotates the fork 26 upward, which in turn drives the link 28 that extends the block 30. When the block 30 is constrained in a chamber 32 in the work deck 34, the door 20 cannot open and the beverage carts are rigidly secured in the bay. The latch 10 features a manual release and can either be manually closed or have the option of an automatic deadlock operation that results in a “close-lock” feature.

To open a secured latch 10, the paddle 22 is lifted to the open position (FIG. 1) which causes the fork 26 and link 28 to pull the latch block 30 downward until it reaches its withdrawn position out of the chamber 32, as seen in FIG. 1. With both latches 10 in this position, the door 20 can be opened. To secure the door 20, the action is reversed when the door is pushed closed. As shown in FIG. 2, with the paddles 22 depressed the latch blocks 30 rise up to be installed in the chamber 32 in the work deck 34.

In an alternative embodiment, the latch 10 is spring loaded to provide an automatic release of the latch block 30 on closure. This involves a spring that is compressed when the paddle is lifted (or placing a spring in tension) to positively lock the latch block in the withdrawn position. A toggle lock or similar device can be used to release the latch, and the movement of the latch block downward on closure of the door would release the toggle lock. This release would allow the latch blocks to be returned to the secure position by the spring, and the paddle itself would re-set automatically.

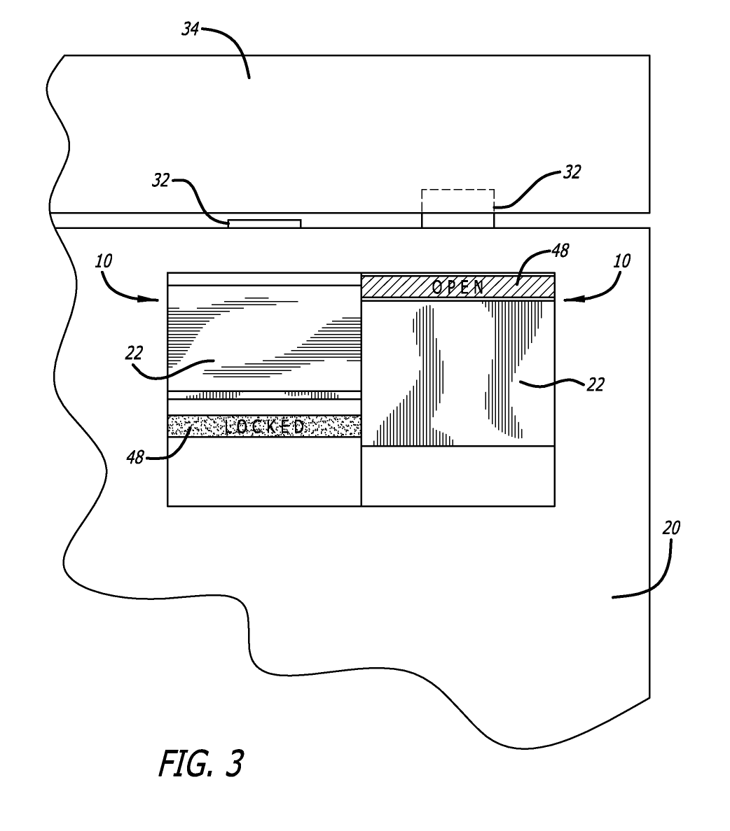

The present invention allows both latches 10 to be opened simultaneously with one hand and eliminates the need for a separate door handle (See FIG. 3). In the event of failure of the latch block spring, a service tool 40 can be inserted and screwed into a concealed access slot 42 above the latch, where the latch block 32 can be pushed upward to secure the door 20. In this configuration, the door 20 could not be opened with the service tool 40 in place.

The latches 10 can be positioned centrally on the door, or offset to the side opposite the hinge. One benefit of the present invention is that the latch system may be integrated into the composite door 20, and is therefore isolated from the cold interior of a chilled compartment to eliminate the possibility of a thermal bridge (i.e., heat transfer resulting in thermal losses). Also, as the latch block receiver requirements are far less substantial, the work deck beam 34 can be removed and replaced with a composite structure within the lower forward section of the work deck. A composite structure is cheaper and lighter than the type of deck beams presently used.

Because the paddles 22 control a pair of latch blocks 32, the present invention allows one handed operation of both primary and secondary latches 10 simultaneously. FIG. 3 illustrates a front view of the paddles 22 and the respective positions of the latch blocks. Color coded indicators 48 can be used to show the position of the latch blocks 32 (e.g., green being the safety position and red being the withdrawn position). Alternatively, the indicators can reveal the words “Locked” and “Open” to indicate the status of the latch system. When the handle 22 is in the down position, the red or “Locked” indicator is hidden while the green or “Open” indicator along an upper portion 54 of the handle 22 is exposed. Conversely, when the handle 22 is extended the red or “Locked” indicator is exposed and the green or “Open” indicator is blocked. Other colors and combinations can also be substituted for these examples.

In addition, the latch can be manually operated or have a secure automatic deadlock action when engaged. Another advantage of the present invention is that the latch 10 is designed to be mounted with the cart bay door 20 as the means of cart retention, eliminating a work deck beam with a resulting saving in weight and elimination of the opportunity for a thermal bridge. The resulting bay door is both safer and more esthetically pleasing while eliminating many of the drawbacks of prior designs. Further, the present invention can be used on all types of narrow or wide bodied commercial aircraft monuments both for new and existing airplane types or variants.

While the foregoing description is intended to be illustrative, it should not be read as limiting the invention to any particular embodiment or embodiments depicted in the figures or described herein. Rather, one of ordinary skill in the art would understand and appreciate that various modifications are available and the present invention is intended to include all such modifications as would be understood and appreciated by the person of ordinary skill in the art.

I claim:

1. A latch for a galley cart bay door, comprising:
a pivoting handle rotating about a spindle;
a fork connected to the spindle for rotation with the pivoting handle;
a drive link connected to the fork, whereby a downward movement of the pivoting handle results in an upward movement of the drive link;
a retention block coupled to the drive link and reciprocating into and out of a chamber above the cart bay door, whereby the cart bay door can be secured by driving the retention block into the chamber by a downward movement of the pivoting handle.

2. The latch of claim 1, wherein the pivoting handle is a paddle.

3. The latch of claim 1, wherein the latch can be operated with one hand.

4. The latch of claim 1, further comprising a spring connected to the pivoting handle for biasing the handle in the closed position.

5. The latch of claim 1, further comprising an access hole in the latch, and a service tool for moving the retention block from outside the door through the access hole.

6. The latch of claim 1, further comprising a pair of status indicators, wherein a first status indicator is visible when the handle is in the closed position, and a second indicator that is visible when the handle is in an open position.

7. The latch of claim 6, wherein the first indicator is the color red and the second indicator is the color green.

8. The latch of claim 1, wherein said latch is integrated into the beverage cart bay door.
